(19) United States
(12) Patent Application Publication
(10) Pub. No.: US 2023/0166131 A1
(43) Pub. Date: Jun. 1, 2023

(54) AIR FILTRATION MASK

(71) Applicant: Fundacion Plenilunio, Menlo Park, CA (US)

(72) Inventor: Mark Heyer, Menlo Park, CA (US)

(21) Appl. No.: 17/986,223

(22) Filed: Nov. 14, 2022

Related U.S. Application Data
(60) Provisional application No. 63/283,996, filed on Nov. 29, 2021.

(51) Int. Cl. A62B 7/10; A41D 13/11; A62B 18/02; A62B 18/10

(52) U.S. Cl. CPC A62B 7/10; A41D 13/11; A62B 18/10; A62B 18/025

(57) ABSTRACT

Air filtration masks are provided. In one exemplary embodiment, an air filtration mask includes a housing configured to be worn over at least a portion of a face of a user, an inhalation airflow channel formed within the housing and configured to receive an inhalation airflow, an exhalation airflow channel formed within the housing and downstream of the inhalation airflow channel, configured to receive an exhalation airflow that is different from the inhalation airflow, an inhalation filter structure in fluid communication with the inhalation airflow channel to allow the inhalation airflow to pass therethrough, the inhalation filter structure configured to yield a filtered inhalation airflow, and an exhalation filter structure in fluid communication with the exhalation airflow channel to allow the exhalation airflow to pass therethrough, the exhalation filter structure configured to yield a filtered exhalation airflow.

### CROSS-REFERENCE TO RELATED APPLICATION

This application claims priority to U.S. Provisional Pat. Application No. 63/283,996 filed on Nov. 29, 2021, and entitled “AIR FILTRATION MASK,” the disclosure of which is incorporated herein by reference in its entirety.

### BACKGROUND

With the arrival of the coronavirus disease 2019 (COVID-19), the use of facemasks has become prevalent. Existing facemask designs, however, are not suitable for long term use. Notably, “one size fits all” or small-medium-large designs are not capable of producing well-fitting, comfortable face masks for all humans, from children to adults, given the huge variety in facial profiles. Furthermore, facemasks need to be comfortable, environmentally friendly, and allow for people to communicate effectively, while keeping people safe and without pulling off the facemask or handling filter surfaces.

Traditional facemasks typically possess other drawbacks that limit their effectiveness. For example, traditional facemasks can trap exhaled air within the facemask, leading to an undesirable mixing of filtered inhaled air and unfiltered exhaled air. This undesirable mixing can potentially transfer contaminants from the unfiltered exhaled air to the filtered inhaled air. Traditional facemasks can also become clogged or soiled over time and require frequent replacement. Traditional facemasks can generally employ the same filter for filtering inhaled and exhaled air, leading to less than optimum filtering performance. The filter materials of traditional facemasks are generally exposed (e.g., to being touched by hands, surfaces, other sources of contamination, etc.), raising the risk of contamination of the filter materials themselves and/or the risk of transferring contaminants present on the filter material to a user’s hands when handled (e.g., placed on the face, removed from the face).

Accordingly, there is a need for improved facemasks that address one or more of these deficiencies, avoiding mixture of filtered inhaled air and unfiltered exhaled air, being less prone to clogging, optimizing filtering for inhaled and exhaled air, and/or avoiding transfer of contaminants from the facemask during handling.

### SUMMARY

Air filtration masks are provided. In one exemplary embodiment, an air filtration mask includes a housing configured to be worn over at least a portion of a face of a user, an inhalation airflow channel formed within the housing and configured to receive an inhalation airflow, an exhalation airflow channel formed within the housing and downstream of the inhalation airflow channel, configured to receive an exhalation airflow that is different from the inhalation airflow, an inhalation filter structure in fluid communication with the inhalation airflow channel to allow the inhalation airflow to pass therethrough, the inhalation filter structure configured to yield a filtered inhalation airflow, and an exhalation filter structure in fluid communication with the exhalation airflow channel to allow the exhalation airflow to pass therethrough, the exhalation filter structure configured to yield a filtered exhalation airflow.

### DESCRIPTION OF DRAWINGS

These and other features will be more readily understood from the following detailed description taken in conjunction with the accompanying drawings, in which:

FIG. 1 is isometric view of one exemplary embodiment of a facemask consistent with the present disclosure including a housing, a hood, and a mouth shield;

FIG. 2 is a schematic diagram illustrating the facemask of FIG. 1 worn on the face of a user;

FIG. 3 is a schematic diagram illustrating a top-down cross-sectional view of an embodiment of the facemask of FIG. 1;

FIG. 4 is a flow schematic illustrating one exemplary embodiment of airflow and filtration performed by the facemask of FIG. 3;

FIG. 5 is a schematic diagram illustrating operation of an exemplary tangential filter in combination with an aerodynamic filter including a plurality of vanes to separate and/or remove water droplets from the airflow;

FIG. 6 is a schematic diagram illustrating exemplary aerodynamic features that can be formed in one or more of the plurality of vanes to guide airflow in paths that facilitate separation of water from the airflow and transfer of the water droplets from the airflow to a tangential filter;

FIG. 7 is a schematic diagram illustrating exemplary configurations of the plurality of vanes that can be employed in conjunction with a tangential filter;

FIG. 8 is a schematic diagram illustrating an exemplary embodiment of another configuration of the plurality of vanes that can be employed in conjunction with a tangential filter;

FIG. 9 is a schematic diagram illustrating an exemplary embodiment of a configuration of the plurality of vanes in the form of flexible vanes that can be employed with a tangential filter;

FIG. 10 is a schematic diagram illustrating exploded and assembled views of one exemplary embodiment of a facemask consistent with the present disclosure;

FIG. 11 is a schematic diagram illustrating an exemplary embodiment of an intake side of the facemask of FIG. 10 illustrating an inhalation filter structure and inhalation airflow; and

FIG. 12 is a schematic diagram illustrating an exemplary embodiment of an exhaust side of the facemask of FIG. 10 illustrating an exhalation filter structure and exhalation airflow.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Embodiments of facemasks and corresponding methods for removal of contaminants (e.g., water droplets, virus particles, other airborne contaminants, etc.) from inhaled or exhaled air are discussed herein.

In general, an air filtration mask, also referred to herein as a facemask, includes a housing configured to be worn over at least a portion of a face of a user. An inhalation airflow channel is formed within the housing and is configured to receive an inhalation airflow. An exhalation airflow channel is also formed within the housing, downstream of the inhalation airflow channel, and is configured to receive an exhalation airflow that is different from the inhalation airflow. An inhalation filter structure is provided in fluid communication with the inhalation airflow channel to allow the inhalation airflow to pass therethrough and yield a filtered inhalation airflow. An exhalation filter structure is also provided in fluid communication with the exhalation airflow channel to allow the exhalation airflow to pass therethrough and yield a filtered exhalation airflow.

Accordingly, embodiments consistent with the present disclosure can include a facemask that can customized on a person-by-person basis. As an example, once a scan of an individual’s face is obtained, a customized facemask can be formed by additive and/or subtractive manufacturing (e.g., three-dimensional printing or other computer-numerically controllable (CNC) processes). Furthermore, once a scan is obtained, any number of customized variations can be produced by a manufacturer. This customization may provide improved comfort and better sealing against the user’s face without the need for gaskets or time-consuming adjustments. Customization can further improve hygiene, as individually customized, form-fitting facemasks are generally less likely to be shared.

In some embodiments, a facemask may also provide improved air filtration, as compared to existing facemask designs. Traditional facemasks employ a single mode of filtration, e.g., transmissive filtration, where a flow of air is passed (transmitted) through a filter to remove particulates from the air prior to inhalation by the user. However, over time, transmissive filters can exhibit reduced effectiveness as they can become clogged by the trapped particulates, water droplets, etc. This can result in exhaled air being trapped behind the transmissive filter, increasing the pressure behind the mask and causing the facemask to lift off the face during respiration. This escape of exhaled air is undesirable for numerous reasons. For example, it can cause fogging of glasses worn by a user. Escape of exhaled air also generally reduces the effectiveness of the facemask, as a portion of the users exhaled air is not filtered at all.

In order to address such deficiencies with currently available approaches, embodiments of the current disclosure may employ more than one mode of filtration. In some embodiments, a tangential filtration, alone or in combination with a transmissive filtration is used. In tangential filtration, air is blown across an exterior surface of the tangential filter rather than through it, and contaminants within the airflow can be captured by the surface of the tangential filter. As airflow is not passed through tangential filters, they are less prone to clogging as compared to transmissive filters. Also, higher flow velocities (e.g., such as for exhaled air, may be more readily accommodated without sacrificing filtration efficiency.

Tangential filters can also be complemented by the further use of aerodynamic filters. Aerodynamic filters can use channels, vanes, or other aerodynamic structures to direct airflow in a manner that causes relatively heavy particles (e.g., water droplets containing virions and/or other contaminants) to separate from the airflow. As an example, an aerodynamic filter can direct airflow such that small water droplets agglomerate into larger, heavier droplets. Alternatively or additionally, an aerodynamic filter can guide the airflow in a manner that converts linear momentum to angular momentum and forms vortices. That is, the path of the airflow curves, which heavier water droplets cannot follow, due to their inertia exceeding the drag forces of the moving air, causing the droplets to enter the tangential filter while the air passes above the tangential filter. Vortices further cause the airflow to rotate rapidly, accelerating heavy droplets to the outside and circulating them over the tangential filter media multiple times, increasing the likelihood of capture by the tangential filter.

Furthermore, traditional facemasks commonly use the same filter for inhaled and exhaled air. However, this is not ideal. Inhaled air is typically relatively dry, with diffuse ambient viral loading and generally smaller particle sizes, while exhaled air is relatively more humid and laden with larger water droplets. Therefore, the requirements for effective inhale and exhale filters are very different in function and form. In certain embodiments of the currently disclosure, a facemask can employ a hybrid design. For example, the hybrid design can include both transmissive and tangential filters, in which the transmissive filter can be employed to filter inhaled air and the tangential filter can be used to filter exhaled air. As a result, the load on the downstream tangential filter can be greatly reduced. Furthermore, the transmissive and tangential filters can be customized for each function, with the transmissive filter removing airborne contaminants (e.g., virions) from the inhaled air and the tangential filter removing water droplets containing virions and/or other contaminants from exhaled air. This functional customization allows the design of the respective filters to be optimized for the purpose of inhale or exhale filtration.

In addition, embodiments of a facemask consistent with the present disclosure can be based primarily on volumetric filter designs, rather than traditional planar filters. Therefore, the interior volume can be optimized to employ multiple filtration strategies that are not available with planar filters (e.g. aerodynamic control vanes, bulk planar filters, tangential filters, diffuse low density materials, hybrid designs, etc.), allowing the filter size to be reduced. In a nonlimiting embodiment, the filter volume can be approximately 60 cm³. For comparison, a planar transmissive filter would require an area of approximately 2,400 cm² (nearly 49 cm x 49 cm) to achieve an equivalent volume.

In addition, the effort of breathing (EOB) for a planar transmissive facemask can be determined by the density of the filter material and the area of the mask. Therefore, more effective filtration (e.g., N95) when performed by a planar transmissive filter can require much larger area than the area of human nostrils (about 2x2 cm²). In embodiments of a facemask consistent with the present disclosure, however, the inhale and exhale ports can be equal to or smaller than the nostril area because they are unencumbered by dense filter material, although a thin membrane can be used as a preliminary filter stage if required and as determined by the overall EOB.

Additionally, in traditional facemask designs, inhaled and exhaled air can flow within the same area and undesirably mix together. To address this issue, separate channels may be provided for flow of inhaled air into the facemask and flow of exhaled air out of the facemask. Such a separation of inhaled air and exhaled air may allow the filtration technology of the facemasks consistent with the present disclosure to be tailored based on the type of air to be filtered in different parts of the facemask, thereby increasing the overall filtration efficiency of such a facemask.

Additionally, in traditional facemasks, the outer surface of the facemask is typically the contaminated filter material. When the facemask is removed, handled, and subsequently reused, contaminants trapped by the filter can be transferred to the user’s hands, increasing the risk of infection. In contrast, embodiments of the disclosed facemask are capable of isolating filter materials from both the user and the environment, greatly reducing the risk of contamination from handling the facemask.

As described in greater detail below, during use of the facemask, when the user inhales via the nose, air (e.g., from an ambient environment) is drawn into the inhalation filter structure where it is filtered. Filtered inhaled air exiting the inhalation filter structure is subsequently directed to the nose. Exhaled air exiting the nose passes through the exhalation filter where it is filtered. Filtered exhalation air is subsequently directed out of the facemask for release to the environment.

Inhalation filter structures can have a variety of configurations. As further discussed in greater detail below, in some embodiments, the inhalation filter structure can be a transmissive filter (e.g., a matrix filter, an aerodynamic filter, a plate filter), a tangential filter, or any combination thereof). A person skilled in the art will appreciate that other filter technologies can be employed, alone or in any combination with those discussed above, for the inhalation filter structure.

Matrix filters can be in the form of a planar surface or pleated planar surface containing a filter media. In certain embodiments, the filter media can be woven. Examples of woven structures can include, but are not limited to, cotton, pressed fibers (e.g., paper), metallic threads alone or incorporated into a mat, nano-materials or fabrics (e.g., spun nylon nano-threads).

Aerodynamic filters can include a plurality of channels, vanes, or other aerodynamic structures (e.g., wings, louvers, etc.) to direct airflow in a manner that causes relatively heavy particles (e.g., water droplets containing virions and/or other contaminants) to separate from airflow received by the aerodynamic filter. In certain embodiments, at least a portion of an aerodynamic filter can be coated with a surfactant, biocide, or combinations thereof. The surfactant can facilitate capture of airborne virions and/or virion containing water droplets, while the biocide can destroy or render harmless the captured virions. In further embodiments, at least portion of a surface of the aerodynamic filter adjacent the airflow can contain pores having a geometry (e.g., diameter, shape, etc.) and distribution to adjust the surface area of the aerodynamic filter in contact with airflow and/or water droplets. In this manner, capture of airborne virions and/or virion containing water droplets can be further facilitated.

Plate filters can include a plurality of plates (e.g., approximately parallel plates) having porous surface and high surface area. In certain embodiments, at least a portion of a plate filter can be coated with a surfactant, biocide, or combinations thereof. In further embodiments, at least portion of a surface of the plate filter adjacent the airflow can contain pores having a geometry (e.g., diameter, shape, etc.) and distribution to adjust the surface area of the plate filter in contact with airflow and/or water droplets. In this manner, capture of airborne virions and/or virion containing water droplets can be further facilitated.

A tangential filter is oriented with respect to an airflow such that the airflow passes across an exterior surface of the tangential filter, rather than through it. In this manner, contaminants within the airflow can be captured by the surface of the tangential filter. In certain embodiments, at least a portion of a tangential filter can be impregnated with a biocide. In further embodiments, at least portion of tangential filter can contain pores having a geometry (e.g., diameter, shape, etc.) and distribution to adjust the surface area of the tangential filter in contact with airflow and/or water droplets. In this manner, capture of airborne virions and/or virion containing water droplets can be further facilitated.

Exhalation filter structures can have a variety of configurations. As further discussed in greater detail below, in some embodiments, the exhalation filter structure can be a transmissive filter (e.g., a matrix filter, an aerodynamic filter, a plate filter), a tangential filter, or any combination thereof. A person skilled in the art will appreciate that other filter technologies can be employed, alone or in any combination with those discussed above, for the exhalation filter structure.

In certain embodiments, the inhalation filter structure is a transmissive filter in the form of a plate filter. The exhalation filter structure includes an aerodynamic filter in fluid communication with a tangential filter. At least a portion of the transmissive inhalation filter and/or the aerodynamic filter can be coated by a biocide, a surfactant, or combinations thereof. The tangential filter can be further impregnated with a biocide.

An exemplary air filtration mask can include a variety of features to facilitate filtration of one or more contaminants from inhalation airflow and exhalation airflow, as described herein and illustrated in the drawings. However, a person skilled in the art will appreciate that the air filtration mask can include only some of these features and/or it can include a variety of other features known in the art. The air filtration masks described herein are merely intended to represent certain exemplary embodiments.

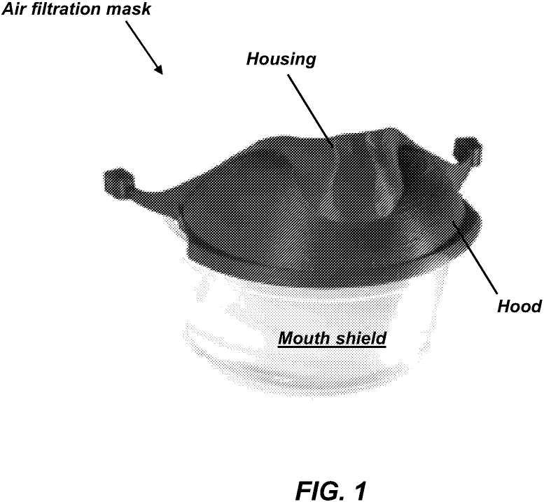

FIG. 1 is isometric view of one exemplary embodiment of a facemask consistent with the present disclosure includes a housing, a hood, and a mouth shield (also referred to herein as a shield). The hood is mounted to the housing by a fluid-type coupling (e.g., an adhesive, interference fit, or other substantially fluid-tight coupling mechanism) and covers the flow channels, filters, and valves to provide isolation of the inhalation airflow and exhalation airflow from the ambient environment while within the facemask.

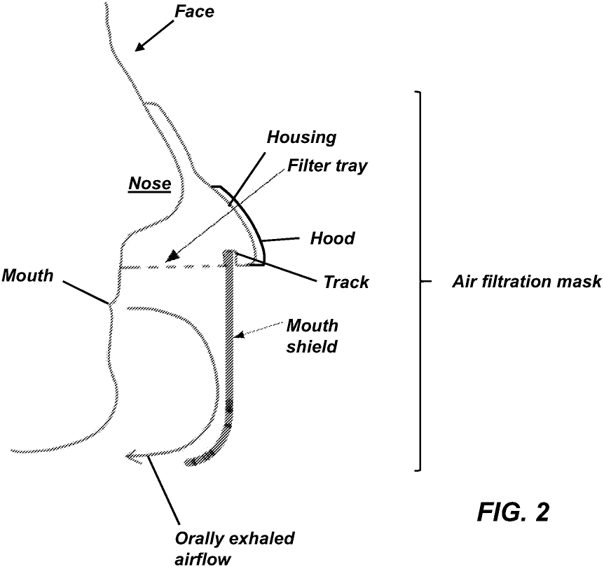

FIG. 2 is a diagram illustrating the facemask of FIG. 1 worn on the face of a user. As shown, the housing is configured to be worn over a portion of a face (e.g., the nose) of the user. As discussed in detail below, the housing includes inhalation filter and exhalation filter structures in fluid communication with separate inhalation airflow and exhalation airflow channels, respectively. The inhalation and exhalation filter structures can be integrally formed within the housing or removably attached to the housing. The housing can further include a hood that encloses the inhalation and exhalation filter structures.

In certain embodiments, the housing can be formed by additive or subtractive manufacturing (e.g., three-dimensional printing or other computer-numerically controllable (CNC) processes). For example, a digital three-dimensional model (e.g., a three-dimensional point cloud) of the user’s face can be captured by a three-dimensional scanning process. Using a computer aided design (CAD) program, a mask model can be generated based upon the three-dimensional model of the user’s face. Once the mask model is generated, a customized facemask can be fabricated by three-dimensional printing. This customization provides improved comfort and better sealing against the user’s face without the need for gaskets or time-consuming adjustments. Customization can further improve hygiene, as individually customized facemasks cannot be shared.

The mouth shield is attached to the housing (e.g., an underside of the housing) and is configured to cover at least a portion of a mouth of the user when the housing is worn over at least a portion of the face of the user. As an example, a track (e.g., a slot) can be formed in the housing that is configured to receive a portion of the mouth shield to secure the mouth shield thereto. In certain embodiments, the mouth shield surrounds the user’s mouth when worn over at least a portion of the user’s face.

The shape of the mouth shield can be configured to redirect at least a portion of orally exhaled airflow incident thereon back towards the user (e.g., towards the users chin, neck, or body). As an example, a portion of the mouth shield (e.g., a lower portion) can be curved towards the user when worn over at least a portion of the user’s face. In this manner, the mouth shield can inhibit flow of orally exhaled air towards surrounding individuals.

In further embodiments, the mouth shield can be transparent or semi-transparent. This allows visibility of the mouth to convey expression and avoid misunderstanding. In contrast, current facemask designs are typically opaque and do not allow for visualization of the mouth.

As discussed in greater detail below, the facemask can also include a filter tray configured to be removably attached to the housing (e.g., to an underside of the housing). The filter tray can be configured to hold one or more filters, as discussed in greater detail below.

In certain embodiments, the filter tray can adopt one of a variety of configurations in combination with one or more filters. In one aspect, the one or more filters and filter tray can be permanently attached to one another. In another aspect, the one or more filters can be disposable, configured for removal from the filter tray and replacement. In a further aspect, the one or more filters can be reusable, configured for removal from the filter tray, cleaned, and reinserted into the filter tray.

In further embodiments, inhaled and/or exhaled air can flow through the filter tray. Thus, air inhaled into the facemask and exhaled from the facemask can be behind the mouth shield. This design can inhibit the user from inhaling air that has been recently exhaled by a nearby individual, as well as inhibiting a nearby individual from inhaling air that has been exhaled by the user.

In further embodiments, a facemask consistent with the present disclosure can be customized not only to the user’s face but to include devices having functionality configured to facilitate operations performed by workers in specific markets. Examples can include, but are not limited to, restaurants, retail outlets, government employees (e.g., point of sale functionality for processing credit/debit card payments), police/military/tactical (e.g., lights, communication equipment, sensors, etc.), and the like.

Further embodiments of the disclosed facemask can be customized for fashion. As an example, portions of the housing can be removably interchangeable (e.g., the hood), allowing the use of customized “skins” to personalize the mask. Such personalization can include, but is not limited to, colors, custom painting, words, logos, characters, or other adornments.

In additional embodiments, customization can include the ability to mount one or more other devices to the housing. In one aspect, the housing can include holders of various design that are configured to attach headbands to secure the facemask to the user. In another aspect, components that are custom molded to the user’s face can be mounted to the housing. In a further aspect, the housing can optionally include mounts for securing other accessories. In another aspect, the housing can optionally include molded-in accessories. In a further aspect, a medical device such as a hearing aids can be mounted to the housing..

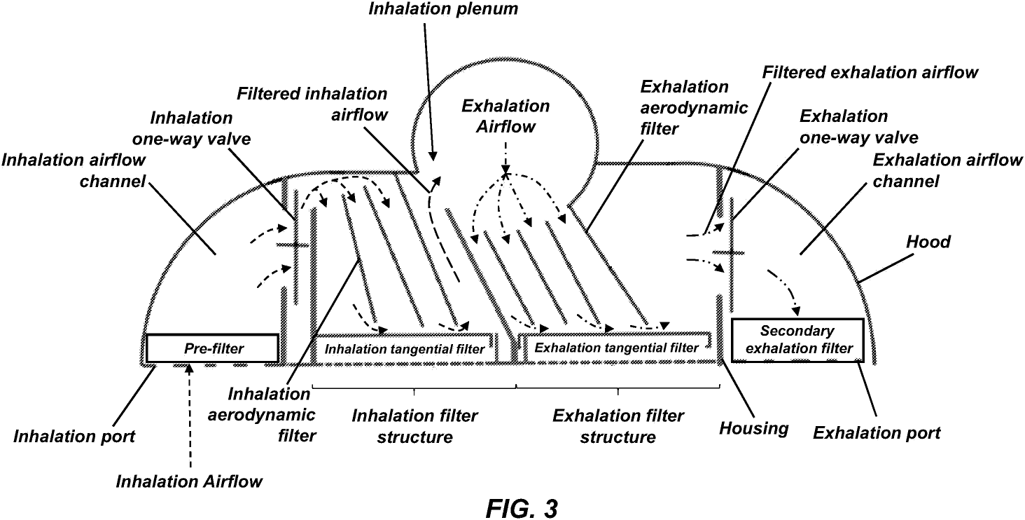

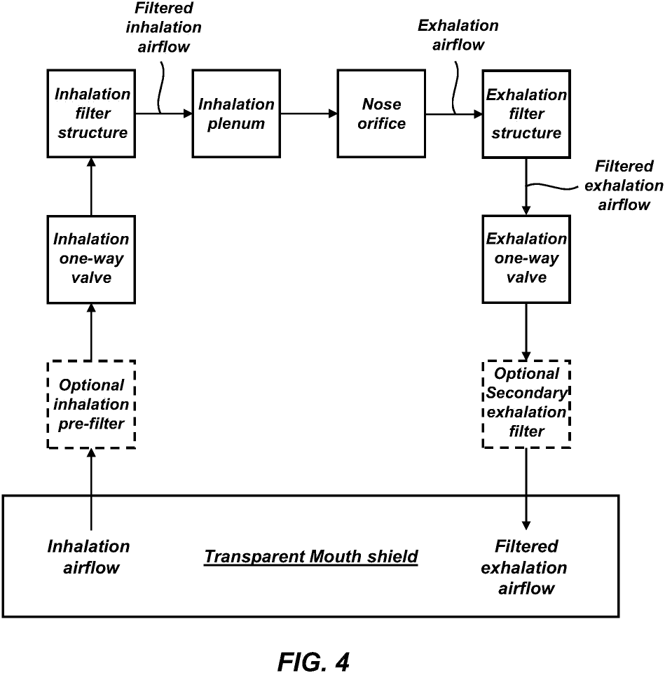

FIG. 3 is a schematic diagram illustrating a top-down cross-sectional view of an embodiment of the facemask of FIG. 1. A corresponding flow diagram illustrating one exemplary embodiment of airflow and filtration performed by the facemask is presented in FIG. 4. As shown, the housing of the facemask includes an inhalation airflow channel and an exhalation airflow channel formed therein. The inhalation airflow channel is configured to receive an inhalation airflow, and the exhalation airflow channel is configured to receive an exhalation airflow. An inhalation filter structure is provided in fluid communication with the inhalation airflow channel and is configured to yield a filtered inhalation airflow. An exhalation filter structure is provided in fluid communication with the exhalation airflow channel, and is configured to yield a filtered exhalation airflow.

As shown, the inhalation airflow enters the inhalation airflow channel through an inhalation port. As an example, the inhalation port can be a portion of the filter tray. An inhalation one-way valve is positioned in fluid communication with the inhalation airflow channel and is configured to permit downstream flow of the inhalation airflow towards the inhalation filter structure. The inhalation one-way valve can inhibit upstream flow in the reverse direction, towards the inhalation port, preventing escape of the inhalation airflow received by the facemask.

Once received within the inhalation airflow channel, the inhalation airflow can be filtered. In one embodiment, the inhalation airflow can be received by a transmissive inhalation pre-filter. The inhalation pre-filter can be positioned within the portion of the filter tray including the inhalation port and configured to remove large particulates from the inhalation airflow prior to receipt by the inhalation filter structure. In certain embodiments, the inhalation pre-filter can be a woven structure formed from natural or synthetic materials. Examples can include, but are not limited to, cotton, metallic threads, or pressed fibers (e.g., paper). In other embodiments, the inhalation pre-filter can be a high-surface area (e.g., porous) solid filter, or a filter structure formed from a meta-material.

In certain embodiments, the meta-material can be a fiber/matrix composite (e.g., a nano-fiber/solid plastic meta-material). As an example, a meta-material filter can be formed using a three-dimensional printing process, such as fluid deposition manufacturing (FDM) and electrospinning (ES). FDM involves extrusion of a molten bulk material (e.g., a plastic) through a nozzle, laying down layers of the matrix material and building up a finished object. ES extrudes a melt or solution of the fiber material (e.g., a plastic, silver, etc.) from the tip of a needle. The needle and an oppositely charged receiving surface create electrostatic attraction that causes the extruded fiber material to “flow” from the needle to the plate, hardening controllably into a fiber having a selected diameter. As an example, the fibers can possess diameters that are nano- or micro-scale (e.g., approximately 1-10 µm). By mounting both FDM and ES extruders on a common multi-axis (e.g., X-Y-Z) computer controlled gantry, the two systems can cooperatively print materials. For example, the FDM extruder may lay down layers of the matrix structure. After deposition of each matrix layer, the ES extruder lays down a layer of nano fibers across the structure, like a spider web. A 1 mm FDM grid cell (10⁻³ m) could support up to about 1,000 nano-fibers across its opening. Common FDM printers can create layers that are approximately 0.1 mm thick.

The unique characteristic of nano-fibers is their extremely high surface area. Thus a cubic meta-material filter formed from layers of silver nano-fibers embedded in a solid plastic matrix could create an effective viral inactivation device. By varying the fiber and matrix materials, as well as their deposition techniques, the design and function of these meta-material filters could be tuned to create compact high performance filtration systems. For example, forming the nano-fibers from an electrically conductive material allows construction of high density electrostatic filters that could be powered by a small lithium battery incorporated into the facemask structure.

Combinations of woven and solid filters are also contemplated.

After passing through the inhalation one-way valve, the inhalation airflow is received by the inhalation filter structure. As shown, the inhalation filter structure can include an aerodynamic filter having a plurality of vanes and an inhalation tangential filter. In certain embodiments, at least portion of a surface of the aerodynamic filter adjacent the airflow can contain pores having a geometry (e.g., diameter, shape, etc.) and distribution to adjust the surface area of the aerodynamic filter in contact with airflow. In this manner, capture of airborne virions can be facilitated.

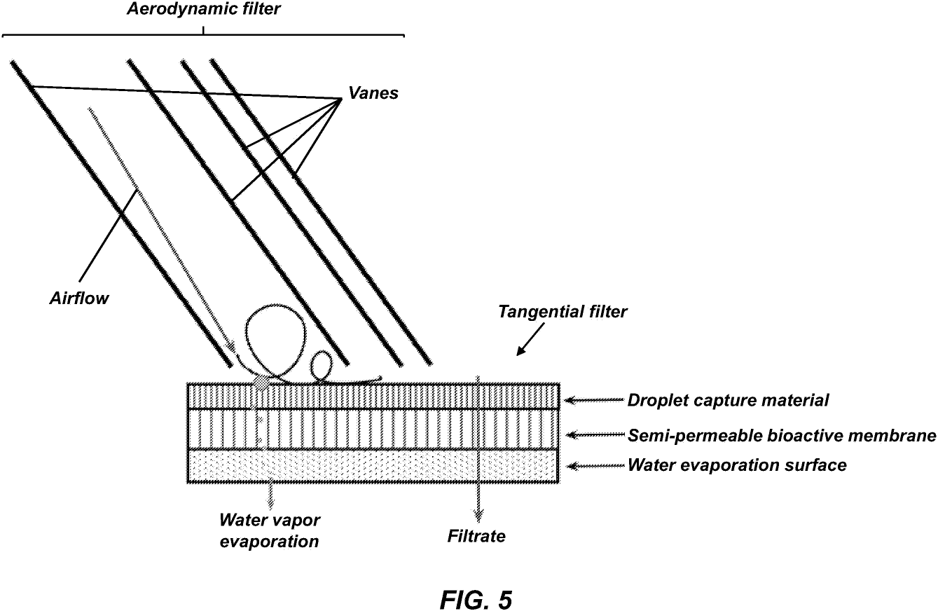

As illustrated in FIG. 5, the vanes can also be configured to direct the inhalation airflow in circular, vortex-like paths that move adjacent to the surface of the inhalation tangential filter. The circular path of the vortex accelerates particulates (e.g., airborne virions, virion containing water droplets) within the inhalation airflow into contact with the inhalation tangential filter during successive rotations, improving the likelihood of particulate capture by the inhalation tangential filter.

In further embodiments, a surfactant and/or a biocide can be applied as a coating to at least a portion of at least one vane of the plurality of vanes. The surfactants can be configured to trap virions and can include, but are not limited to, one or more of activated charcoal, sodium lauryl sulfoacetate, etc.) Examples of the biocide can include, but are not limited to, nanosilver.

As further illustrated in FIG. 5, the tangential filter can include a plurality of functional layers (e.g., first, second, and third layers). The first layer can be configured to capture droplets (e.g., water droplets). The second layer can be semi-permeable bioactive membrane. As an example, the second layer can be impregnated with a biocide (e.g., nanosilver). The third layer can be a water evaporation surface configured to facilitate evaporation of captured droplets therefrom.

In use, the vanes of the aerodynamic filter direct and accelerate airflow into the surface of the first layer of the tangential filter. The function of this first layer is to cause airborne virions and/or virion containing water droplets o adhere thereto. The first layer can be further configured to cause captured water droplets to break down by reducing their surface tension. The contents of the water droplets, water and contaminants, are thus released. In an embodiment, this capture and/or surface tension reduction functionality can be caused by coating at least a portion of the first layer with a surfactant (e.g., sodium lauryl sulfoacetate). Notably, surfactant capture is one of the most effective methods of capturing lipid shell virions, which can potentially then be destroyed by the shear forces of passing air streams.

In addition, the first layer can further contain pores having a geometry (e.g., size, shape) and/or distribution configured to allow transport of the contents of the water droplet to the second layer. As noted above, the second layer can be a bioactive membrane impregnated with a biocide configured to destroy or render virions harmless.

The third layer is a water evaporation surface (WES). The third layer receives downward, primarily liquid, flow from the first and second layers. Its function is to act as a buffer for liquids and to evaporate them into the ambient air. It should thus have high liquid retention capacity and also high surface area to promote evaporation. Examples of materials forming the third layer can include, but are not limited to, polyvinyl acetate and nano-fiber mats, each of which can hold up to ten times its weight in liquid and have high surface area for evaporation. In additional embodiments, the tangential filter can require reduced maintenance or replacement, as compared to other filters, as it is less prone to clogging. With further reference to FIG. 5, the tangential filter experiences a pressure gradient, with a high pressure on the input side (e.g., the top side) relative to the ambient pressure on the opposite side (e.g., bottom side) of the tangential filter. Since the tangential filter is designed to be semi-permeable, a tangential airflow is bled from the airflow across the surface of the tangential filter, and passes through the tangential filter due to the pressure gradient. In exemplary embodiments of a facemask consistent with the present disclosure, this tangential airflow flow is used to carry water and other contaminants through the tangential filter, where they may be exposed to one or more biocidal agents. At the bottom surface, the water and inactivated contaminants are evaporated into the ambient air. As a result, the number of hours of use between cleaning/replacement of the tangential filter can be on the order of multiple days to weeks, assuming the user is not producing an excess of mucous.

In further embodiments, the inhalation and exhalation one-way valves are configured to avoid mixing inhalation airflow and exhalation airflow. In one aspect, during inhalation, the inhalation one-way valve is in an open position and the exhalation one-way valve is in a closed position. As a result, the filtered exhalation airflow is inhibited from flowing upstream towards nose to mix with the filtered inhalation airflow. In another aspect, inhalation and exhalation one way valves are configured such that, during exhalation, the inhalation one-way valve is in a closed position and the exhalation one-way valve is in an open position. Beneficially, this configuration avoids exposure of the tangential filter to re-breathed air, as with a traditional facemask, reducing the risk of secondary infection.

In this manner, harmful virions present in droplets captured by the filter media can be removed from the droplets by the second layer, leaving harmless liquid to be evaporated from the third layer.

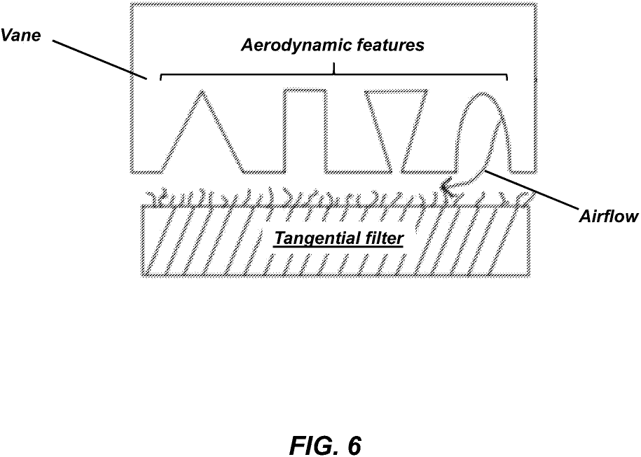

FIG. 6 presents a side view of an example vane of an aerodynamic filter illustrating different embodiments of aerodynamic features (e.g., apertures) that can be formed within one or more of the vanes in order to facilitate vortex formation. Examples of the aerodynamic features can include, but are not limited to, triangular, rectangular, and ovoid shapes. Other straight-sided or curved geometric shapes can be employed without limit. In certain embodiments, a single geometric feature can be formed in a vane. In other embodiments, a plurality of geometric features can be formed in a vane. The plurality of geometric features can be the same or any combination of two or more aerodynamic features. Similarly, the plurality of vanes can include vanes having no aerodynamic features, one aerodynamic feature, or a plurality of aerodynamic features in any combination.

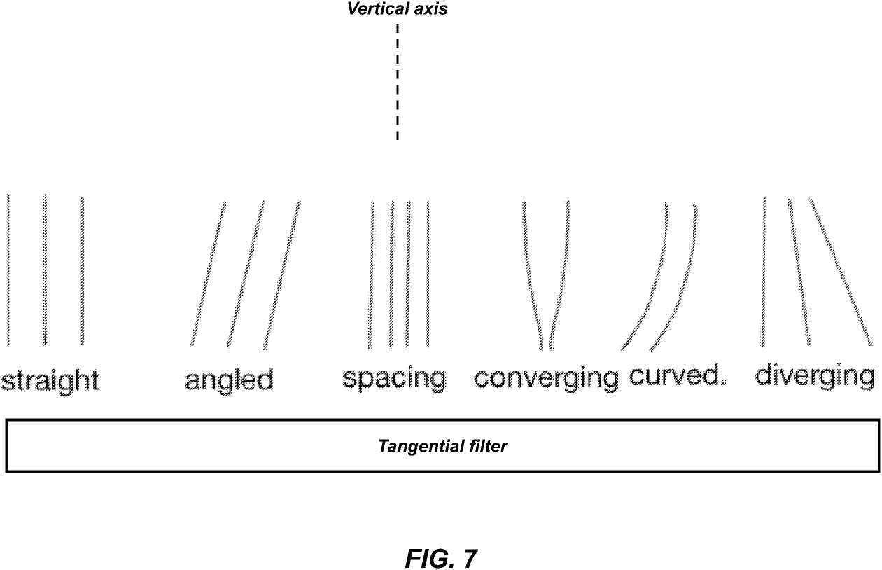

As further illustrated in FIG. 7, vanes can adopt a variety of different configurations with respect to one another. Examples can include, but are not limited to straight (e.g., oriented parallel to one another and to a vertical axis), angled (e.g., oriented parallel to one another and at a non-zero angle to the vertical axis), converging (having a separation distance between adjacent vanes that decreases in the vertical direction approaching the filter media), diverging (having a separation distance between adjacent vanes that increases in the vertical direction approaching the tangential filter), curved (maintaining a constant separation distance between adjacent vanes along their length). In further embodiments, the spacing between neighboring vanes can be different.

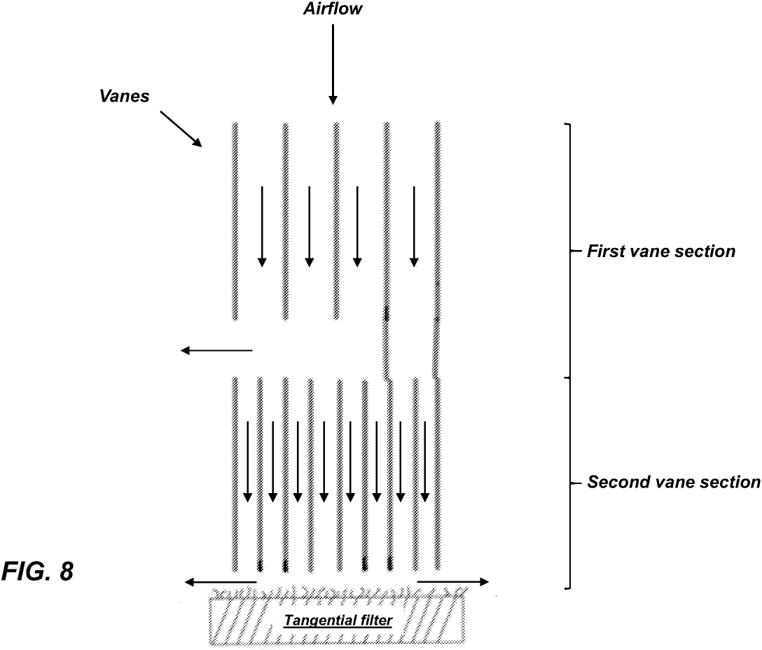

FIG. 8 is a schematic diagram illustrating further embodiments of different configurations of the vanes that can be employed in conjunction with the tangential filter. As shown, a first vane section can be in fluid communication with a second vane section. The first vane section can have a first spacing between adjacent vanes and the second vane section can have a second spacing between adjacent vanes that is different from (e.g., smaller than) the first spacing. In additional embodiments, there can be a gap between the first and second vane sections, allowing airflow to bypass the second vane section prior to the tangential filter.

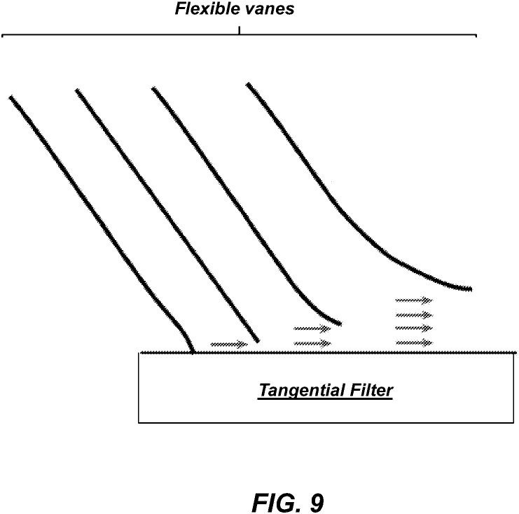

FIG. 9 is a schematic diagram illustrating embodiments of additional configurations of the vanes in the form of flexible vanes. The flexible guide vanes can flex in a predetermined direction in response to different flow rates of the airflow. For example, at a relatively low flow rate, an amount of flexure of the flexible guide vane can be small, resulting in a relatively small distance separating an end of the flexible guide vane from the surface of the tangential filter media. As the flow rate increases, an amount of flexure of the flexible guide vane can also increase, resulting in a relatively large distance separating the end of the flexible guide vane from the surface of the tangential filter media. In this manner, the flexible vanes can double as the one-way valve. Accordingly, embodiments employing the flexible vanes can omit the separate inhalation one-way valve.

The inhalation airflow output by the inhalation filter structure, referred to herein as filtered inhalation airflow, is received by an inhalation plenum. The inhalation plenum is part of the inhalation airflow channel and guides the filtered inhalation airflow to the portion of the housing that receives the user’s nose. The user can subsequently inhale the filtered inhalation airflow through their nose orifices.

When exhaling, the exhalation airflow is received by the exhalation airflow channel and is directed to the exhalation filter structure. The exhalation filter structure can include an aerodynamic filter and an exhalation tangential filter. The aerodynamic filter and exhalation tangential filter of the exhalation filter structure can be provided according to any of the embodiments discussed above (e.g., FIGS. 5-9) regarding the aerodynamic filter and inhalation filter of the inhalation filter structure to facilitate tangential filtration of the exhalation airflow.

The exhalation airflow output by the exhalation filter structure, referred to herein as filtered exhalation airflow, further travels through the exhalation airflow channel to an exhalation one-way valve. The exhalation one-way valve is configured to permit downstream flow of the inhalation airflow towards the exhalation port and to inhibit upstream flow of the exhalation airflow in the reverse direction, towards the exhalation filter structure, preventing contamination of the filtered exhalation airflow. In embodiments where the exhalation guide vanes are flexible and perform one-way valve functionality, a separate exhalation one-way valve downstream from the exhalation filter structure can be omitted.

In further embodiments, the inhalation and exhalation one-way valves are configured to avoid mixing a significant amount of inhalation airflow and exhalation airflow. During inhalation, the inhalation one-way valve is in an open position and the exhalation one-way valve is in a closed position. During exhalation, the inhalation one-way valve is in a closed position and the exhalation one-way valve is in an open position. As a result, during inhalation, air is drawn directly into the nose opening through the inhalation plenum. It is appreciated that, while a small amount of exhalation airflow may blend with the inhalation airflow, this amount is insignificant, e.g., up to about 4 cc (0.004 liters), within a volume of 1-2 liters of inhaled air.

In addition to airway control, the closed exhalation one-way valve can also prevent air within the bioactive section(s) of the filter from entering the nose. During inhalation, the tangential filter experiences a small negative pressure, which can, in theory, drive contaminants out of the tangential filter for inhalation through the nose. However, in practice, the time required for airflow to pass through the tangential filter is much longer than the breathing cycle time. As a result, no significant amount of contaminants can be released from the tangential filter and inhaled.

During exhalation, the exhalation one-way valve opens and the inhale valve closes, establishing the exhalation airflow channel. Exhalation airflow is prevented from entering the inhalation plenum both by air pressure. That is, the pressure adjacent to the nose is higher than that away from the nose, inhibiting airflow from the inhalation plenum towards the nose. Furthermore, as discussed above, the configuration of the inhale plenum and vanes of the aerodynamic filter such that exhalation airflow creates a vortex. This vortex further blocks the entry of exhalation airflow into the inhalation plenum.

Optionally, a secondary exhalation filter can be provided in fluid communication with the exhalation airflow channel, downstream from the exhalation filter structure and upstream from the exhalation port. In certain embodiments, the secondary exhalation filter can be configured to capture and destroy or inactivate virions. As an example, the secondary exhalation filter can be a plate filter including a plurality of parallel plates formed from a solid material having high surface area (e.g., a porous surface). At least a portion of at least one of the plurality of plates of the secondary exhalation filter can be coated with a surfactant and/or a biocide to facilitate virion trapping and destruction/inactivation. Examples of the surfactants can include, but are not limited to, one or more of activated charcoal, sodium lauryl sulfoacetate, etc.) Examples of the biocide can include, but are not limited to, nanosilver.

The filtered exhalation airflow subsequently exits the facemask via the exhalation port. As discussed above, because the exhalation port is positioned at the underside of the facemask and behind the mouth shield, the filtered exhalation airflow is not ejected outward from the user. Beneficially, this can prevent inhalation of the filtered exhalation airflow by nearby individuals, providing an added measure of protection from accidental transmission of harmful virions.

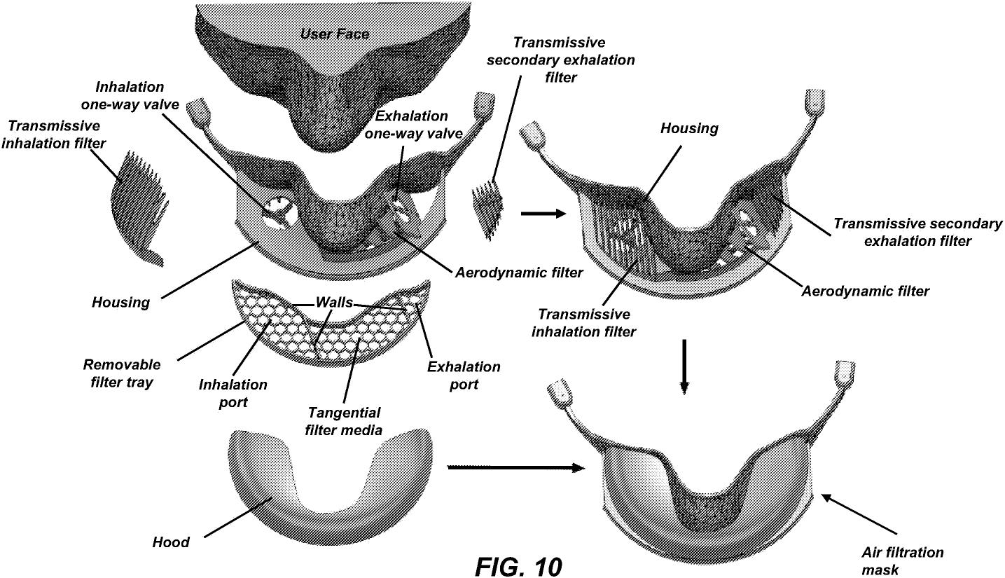

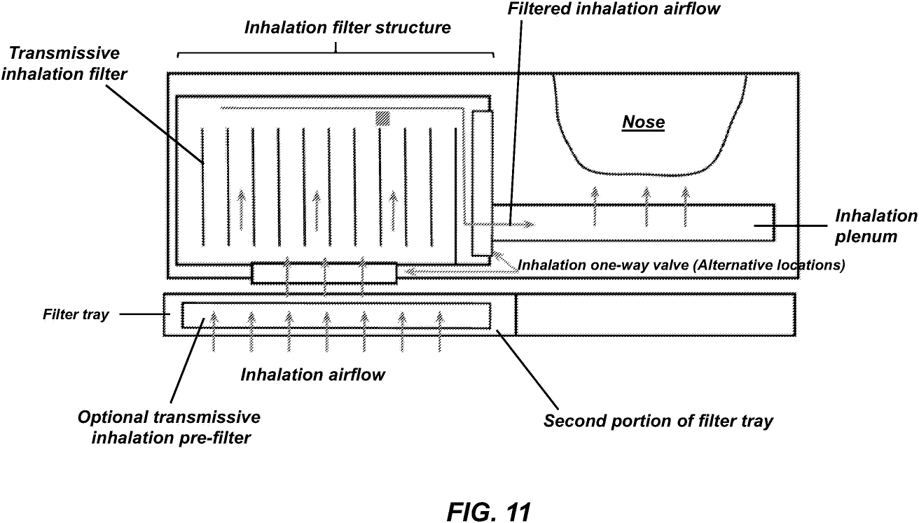

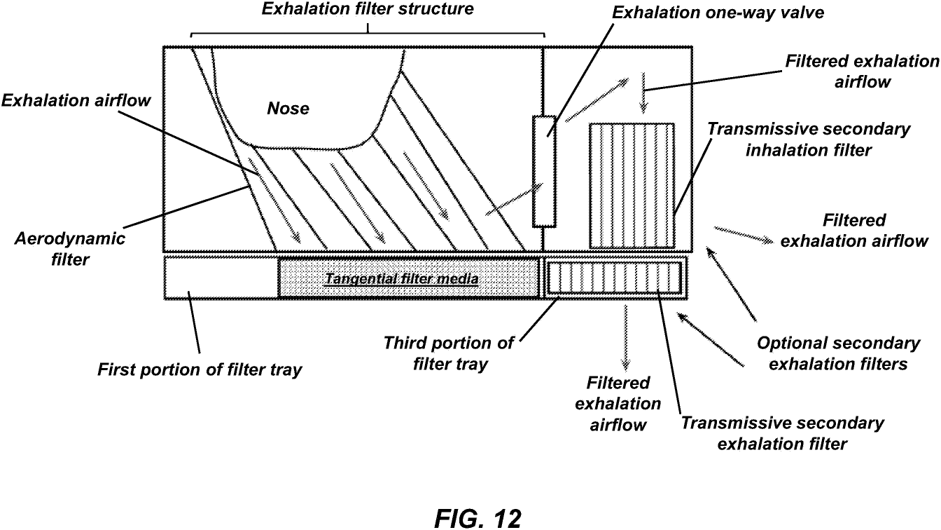

FIG. 10 is a schematic diagram illustrating exploded and assembled views of another exemplary embodiment of the present facemask. While not shown, it can be understood that the facemask of FIG. 10 also includes the mouth shield configured for mounting to the housing, as discussed above. Further, the facemask of FIG. 10 can include additional features, such as those described above. Corresponding diagrams illustrating filtration of the inhalation airflow and exhalation airflow are illustrated in FIGS. 11-12, respectively.

As discussed in detail below, the facemask of FIGS. 10-12 can include the housing, the inhalation airflow channel, the exhalation airflow channel, the inhalation filter structure, and the exhalation filter structure. However, the configuration of filters employed for filtering the inhalation airflow are is different from that discussed previously in regards to FIG. 3. This difference is based upon an appreciation that the source of the inhalation airflow (e.g., the ambient environment) is different from the source of the exhalation airflow (e.g., from the user’s nose). That is, the inhalation and exhalation airflow are different from one another. As an example, the inhalation airflow can be relatively dry, with diffuse ambient viral loading. In contrast, the exhalation airflow can be relatively humid and laden with water droplets. Thus, in order to maximize filtration efficiency of the inhalation airflow and exhalation airflow, at least a portion of the filters employed for filtration of inhalation and exhalation airflow can be different.

As shown, the transmissive inhalation pre-filter is optionally provided. When present, the transmissive inhalation pre-filter can be positioned within a portion of the filter tray, in fluid communication with the inhalation filter structure, upstream from the inhalation filter structure and downstream from the inhalation port. The configuration of the transmissive inhalation pre-filter can be provided as discussed above with respect to FIG. 3, configured to remove large particulates from the inhalation airflow prior to receipt by the inhalation filter structure and in the form of a woven structure, a high-surface area (e.g., porous) solid filter, or combinations thereof.

The inhalation filter structure of FIGS. 10-12 can be configured to capture and inactivate virions. As an example, the secondary exhalation filter can be a transmissive inhalation filter in the form of a plate filter as discussed above with regards to the secondary exhalation filter, including a plurality of parallel plates formed from a solid material having high surface area (e.g., a porous surface). At least a portion of at least one of the plurality of plates of the secondary exhalation filter can be coated with a surfactant and/or a biocide to facilitate virion trapping and eradication. Notably, the use of a plate filter is particularly well suited for filtration of the inhalation airflow, as it is expected that the inhalation airflow is relative dry but populated with airborne virions that can be readily captured and eradicated by the coated porous plates.

As further shown in FIG. 11, the inhalation one-way valve can be provided to permit downstream flow of the inhalation airflow, towards the user’s nose, and to inhibit upstream flow of the inhalation airflow towards the inhalation port. The position of the inhalation one-way valve can be varied. In one embodiment, the inhalation one-way valve can be positioned upstream from the inhalation filter structure. In alternative embodiments, the inhalation one-way valve can be positioned downstream from the inhalation filter structure.

The filtered inhalation airflow output by the inhalation filter structure is received by the inhalation plenum and guided therein to the portion of the housing that receives the user’s nose. The user can subsequently inhale the filtered inhalation airflow through their nose orifices.

When exhaling, the exhalation airflow is received by the exhalation airflow channel and is directed to the exhalation filter structure. In further embodiments, the inhalation and exhalation one-way valves are configured to avoid mixing inhalation airflow and exhalation airflow. In one aspect, during inhalation, the inhalation one-way valve is in an open position and the exhalation one-way valve is in a closed position. As a result, the filtered exhalation airflow is inhibited from flowing upstream towards nose to mix with the filtered inhalation airflow. In another aspect, inhalation and exhalation one way valves are configured such that, during exhalation, the inhalation one-way valve is in a closed position and the exhalation one-way valve is in an open position. As a result, the filtered inhalation airflow is inhibited from flowing downstream towards the nose to mix with the exhalation airflow.

The exhalation filter structure can include a plurality of exhalation guide vanes and a tangential filter media, as illustrated in FIG. 12. The exhalation guide vanes and second filter media can be formed according to any of the embodiments discussed above (e.g., FIGS. 5-9) regarding the inhalation guide vanes and first filter media to facilitate tangential filtration of the exhalation airflow. Notably, the use of exhalation guide vanes and tangential filter media is particularly well suited for filtration of the exhalation airflow. The exhalation airflow is expected to contain virions in the air as well as water droplets. The plurality of guide vanes, being porous and coated with surfactants and/or biocides can function to capture and eradicate airborne virions. Examples of the surfactants can include, but are not limited to, one or more of activated charcoal, sodium lauryl sulfoacetate, etc.) Examples of the biocide can include, but are not limited to, nanosilver.

Furthermore, the guide vanes can cause the exhalation airflow to flow in a vortex, facilitating agglomeration of water droplets and transport of water droplets on/adjacent to the tangential filter media to facilitate capture by the tangential filter media. Once present within the tangential filter media, at least a portion of the virions present in the captured water droplets can be eradicated (e.g., by the second layer) leaving harmless water to be evaporated from the third layer.

The filtered exhalation airflow output by the exhalation filter structure further travels through the exhalation airflow channel to the exhalation one-way valve. The exhalation one-way valve is configured to permit downstream flow of the inhalation airflow towards the exhalation port and to inhibit upstream flow of the exhalation airflow in the reverse direction, towards the exhalation filter structure, preventing contamination of the filtered exhalation airflow. In embodiments where the exhalation guide vanes are flexible and perform one-way valve functionality, a separate exhalation one-way valve downstream from the exhalation filter structure can be omitted.

At least one secondary exhalation filter can be provided in fluid communication with the exhalation airflow channel, downstream from the exhalation filter structure and upstream from the exhalation port. As shown in FIG. 10, the secondary exhalation filter can be a plate filter comprising a plurality of parallel plates formed from a solid material having high surface area (e.g., a porous surface), as discussed above with regards to the secondary exhalation filter of FIG. 3. At least a portion of at least one of the plurality of plates of the secondary exhalation filter can be coated with a surfactant and/or a biocide to facilitate virion trapping and eradication. Examples of the surfactants can include, but are not limited to, one or more of activated charcoal, sodium lauryl sulfoacetate, etc.) Examples of the biocide can include, but are not limited to, nanosilver.

The filtered exhalation airflow subsequently exits the facemask via the exhalation port. As discussed above, because the exhalation port is positioned at the underside of the facemask and behind the mouth shield, the filtered exhalation airflow is not ejected outward from the user. Beneficially, this can prevent inhalation of the filtered exhalation airflow by nearby individuals, providing an added measure of protection from accidental transmission of harmful virions.

In certain embodiments, the pores of any of the porous filters discussed herein can have a diameter ranging from about 1 µm to about 100 µm or more, depending on their function. This function can be at least one of capture of airborne virions or capture of water droplets in the case of plate filters, aerodynamic filters, the first layer of tangential filters, or combinations thereof. This function can be fluid transport therethrough in the case of matrix filters or the second layer of tangential filters. This function can be evaporation into ambient air in the case of the third layer of tangential filters.

As discussed above, the tangential filter media, the inhalation pre-filter, and secondary transmissive filter can each be positioned within different portions of the filter tray (e.g., a first portion, second portion, and third portion of the filter tray, respectively). Embodiments of the filter tray can further include walls, alone or in combination with other mechanisms (e.g., gaskets, press-fit engagement between the filter tray and housing, etc.) to inhibit fluid communication between respective portions of the filter tray. In this manner, mixing of the inhalation airflow and exhalation airflow can be inhibited, maintaining separation of the inhalation and exhalation airflow channels.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, like-named components of the embodiments generally have similar features, and thus within a particular embodiment each feature of each like-named component is not necessarily fully elaborated upon.

In the descriptions herein and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value or a predetermined tolerance range. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. An air filtration mask, comprising:
a housing configured to be worn over at least a portion of a face of a user;
an inhalation airflow channel formed within the housing and configured to receive an inhalation airflow;
an exhalation airflow channel formed within the housing and downstream of the inhalation airflow channel, configured to receive an exhalation airflow that is different from the inhalation airflow;
an inhalation filter structure in fluid communication with the inhalation airflow channel to allow the inhalation airflow to pass therethrough, the inhalation filter structure configured to yield a filtered inhalation airflow; and
an exhalation filter structure in fluid communication with the exhalation airflow channel to allow the exhalation airflow to pass therethrough, the exhalation filter structure configured to yield a filtered exhalation airflow.

2. The mask of claim 1, further comprising a shield attached to the housing and configured to cover at least a portion of a mouth of the user when the housing is worn over at least a portion of the face of the user.

3. The mask of claim 2, wherein the shield is transparent.

4. The mask of claim 2, wherein a shape of the shield is configured to redirect at least a portion of orally exhaled airflow incident thereon back towards the user.

5. The mask of claim 1, wherein the inhalation filter structure comprises a transmissive inhalation filter.

6. (canceled)

7. The mask of claim 5, wherein the transmissive inhalation filter is formed from a woven structure, a solid porous structure, or any combination thereof.

8. The mask of claim 1, wherein the exhalation filter structure comprises a plurality of vanes.

9. (canceled)

10. (canceled)

11. The mask of claim 1, wherein the exhalation filter structure comprises a tangential membrane filter.

12. The mask of claim 11, wherein the tangential membrane filter is in fluid communication with the plurality of vanes.

13. (canceled)

14. The mask of claim 11, wherein the tangential membrane filter comprises:
a first layer configured to capture water droplets from the exhalation airflow;
a second layer comprising a semi-permeable bioactive membrane; and
a third layer configured to allow evaporation of the captured water droplets therefrom.

15. The mask of claim 1, further comprising a secondary exhalation filter in fluid communication with the exhalation airflow channel and downstream from the exhalation filter structure.

16. The mask of claim 15, wherein the secondary exhalation filter comprises a transmissive exhalation filter.

17. (canceled)

18. The mask of claim 16, wherein the transmissive exhalation filter is formed from a woven structure, a solid porous structure, or any combination thereof.

19. The mask of claim 1, further comprising a filter tray configured for removable attachment to the housing.

20. The mask of claim 19, wherein the filter tray comprises a first portion configured to receive the tangential membrane filter.

21. The mask of claim 1, further comprising a transmissive inhalation pre-filter in fluid communication with the inhalation airflow channel and upstream from the inhalation filter structure.

22. The mask of claim 21, wherein the transmissive inhalation pre-filter is formed from a woven structure, a solid porous structure, or any combination thereof.

23. The mask of claim 21, wherein the filter tray comprises a second portion configured to receive the inhalation pre-filter, and wherein the first and second portions of the filter tray are not in fluid communication with one another.

24. The mask of claim 1, further comprising an inhalation one-way valve in fluid communication with the inhalation airflow channel, the one way inhalation valve configured to permit downstream flow of the inhalation airflow therethrough and configured to inhibit upstream flow of the inhalation airflow therethrough.

25. (canceled)

26. The mask of claim 1, further comprising an exhalation one-way valve in fluid communication with the exhalation airflow channel and downstream from the exhalation filter structure, wherein the one way exhalation valve is configured to permit downstream airflow therethrough and configured to inhibit upstream airflow therethrough.

27. (canceled)
